(19) United States
(12) Patent Application Publication
(10) Pub. No.: US 2017/0149126 A1
(43) Pub. Date: May 25, 2017

(54) ANTENNA DEVICE

(71) Applicant: Naohiro ITOH, Hyogo (JP)

(72) Inventor: Naohiro ITOH, Hyogo (JP)

(21) Appl. No.: 15/348,441

(22) Filed: Nov. 10, 2016

(30) Foreign Application Priority Data
Nov. 19, 2015 (JP) 2015-226322

(51) Int. Cl. H01Q 1/36; H01Q 1/24; H01Q 1/48

(52) U.S. Cl. CPC H01Q 1/362; H01Q 1/48; H01Q 1/24

(57) ABSTRACT

A coil-type antenna device includes a plate-like magnetic member; a coil formed by winding a conductor wire around a plate-like magnetic member; and a fixing structure configured to fix the conductor wire to the magnetic member.

### CROSS-REFERENCE TO RELATED APPLICATIONS

The present application claims priority under 35 U.S.C. §119 to Japanese Patent Application No. 2015-226322, filed on Nov. 19, 2015. The contents of which are incorporated herein by reference in their entirety.

### BACKGROUND OF THE INVENTION

1. Field of the Invention

The present invention relates generally to an antenna device.

2. Description of the Related Art

Magnetic-coupling communication, typified by Near Field Communication (NFC), is used in mobile information terminals, such as smartphones and wearable terminals. To implement such communication feature, an antenna is mounted on such a mobile information terminal. With increasing miniaturization and functionality of such mobile information terminals, demand for miniaturization and reducing the thickness of antennas mounted on such mobile information terminals is also increasing.

However, because conventionally-used loop antennas are susceptible to a nearby metal object, miniaturization of a conventional loop antenna will disadvantageously reduce the antenna's communication area. In contrast thereto, it is known that an antenna that uses a coil formed by winding a conductor wire around a magnetic member is less susceptible to a metal object and therefore has a greater communication area.

However, such a coil-type antenna as described above has a disadvantage that, because the conductor wire is not positionally fixed in the coil, antenna characteristics, such as equivalent LCR (inductance (L), capacitance (C), and resistance (R)) and a communication area, can undesirably fluctuate. Specifically, in an antenna formed by winding a conductor wire around the magnetic member, sliding or the like of the conductor wire, which can occur during transportation or during use, can result in positional displacement of the conductor wire. Furthermore, when the magnetic member has a plate-like shape and is thin and flexible, the conductor wire is prone to positional displacement because the magnetic member can be bent. Positional displacement of the conductor wire has a large effect on communication and power-supply characteristics of such a coil-type antenna as described above. This is because such an antenna exhibits favorable communication characteristics when adjacent windings of the conductor wire are spaced a certain distance.

Under the circumstances, an antenna module, which is configured to adjust LCR of an antenna, for a terminal device and a method for manufacturing the antenna module are disclosed in, for example, Japanese Unexamined Patent Application Publication No. 2015-42007 (Patent Document 1).

However, the method for manufacturing the antenna module for a terminal device disclosed in Patent Document 1 includes forming extra patterns in advance and cutting, at an inspection step, the extra pattern(s) and disadvantageously increases the number of manufacturing steps and cost. Furthermore, the antenna module for a terminal device disclosed in Patent Document 1 can be affected by a nearby metal object such that the antenna's communication area is reduced.

### SUMMARY OF THE INVENTION

According to one aspect of the present invention, a coil-type antenna device includes a plate-like magnetic member; a coil formed by winding a conductor wire around a plate-like magnetic member; and a fixing structure configured to fix the conductor wire to the magnetic member.

### BRIEF DESCRIPTION OF THE DRAWINGS

FIG. 1 is a diagram illustrating an antenna device of a first embodiment;

FIG. 2 is a diagram illustrating an antenna device of a second embodiment;

FIG. 3 is a cross-sectional diagram illustrating an antenna device of a third embodiment;

FIG. 4 is a cross-sectional diagram illustrating an antenna device of a fourth embodiment;

FIG. 5A and FIG. 5B are cross-sectional diagrams illustrating an antenna device of a fifth embodiment;

FIG. 6 is a cross-sectional diagram of a conductor wire used in a coil of a sixth embodiment; and

FIG. 7 is a diagram illustrating application of an adhesive to the conductor wire.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Embodiments of the present invention will be described in detail below with reference to the drawings.

An object of an embodiment is to be provide an antenna device reduced in variations in antenna characteristics by virtue of being less susceptible to a nearby metal object and less prone to positional displacement of a conductor wire.

### First Embodiment

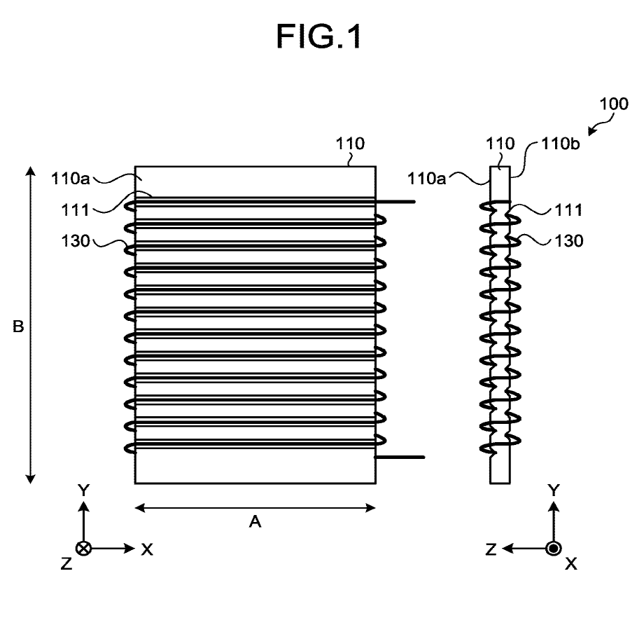

FIG. 1 is a diagram illustrating an antenna device of a first embodiment. In each of FIG. 1 to FIG. 5B, an XYZ coordinate system, which is a Cartesian coordinate system, is defined relative to an antenna device. An antenna device 100, which is a magnetic-coupling antenna device, includes a magnetic member 110 and a coil 130 as illustrated in FIG. 1.

In contrast to a resonant antenna device that transmits or receives a radio wave of a specific frequency by producing resonance with the radio wave, a magnetic-coupling antenna device performs communication by magnetically coupling with magnetic flux generated by an antenna device, with which the magnetic-coupling antenna device performs communication. For this reason, whereas a resonant antenna device generally has a communication area of from a few meters to several kilometers or grater, a magnetic-coupling antenna device generally has a communication area of approximately one meter or smaller, for example.

Hence, magnetic-coupling antenna devices are antenna devices for short-distance communication or near-field communication. The antenna device 100 illustrated in FIG. 1 transmits or receives signals at a frequency of 13.56 MHz, for example.

The magnetic member 110 is made of sintered ferrite formed into a rectangular parallelepiped shape that is 5.3 mm in a length A in the direction (the X-axis direction) along the short side (hereinafter, “short-side direction” and 8.7 mm in a length B in the direction (the Y-axis direction) along the long side (hereinafter, “long-side direction”), for example. The above-described size of the magnetic member 110 is only an example; alternatively, the magnetic member 110 may be, for example, a cube, the length A of which in the short-side direction (the X-axis direction), the length B of which in the long-side direction (the Y-axis direction), and the thickness of which are equal to each other.

While the magnetic member 110 has the plate-like shape, the shape of the magnetic member 110 may be determined as desired depending on the size, shape, and the like of a space where the antenna device 100 is to be mounted and depending on a necessary communication area, which depends on characteristics of the antenna device 100. The material of the magnetic member 110 is not limited to sintered ferrite, and iron, nickel, manganese, zinc, or an alloy of these metals may alternatively be used so long as it is what is generally referred to as a ferromagnetic material.

The magnetic member 110 may be a flexible sheet member having flexibility. The magnetic member 110 may be a member that is deformable to conform to the shape of a casing, to which the magnetic member 110 is to be attached.

The coil 130 is formed by winding a conductor wire around the magnetic member 110 in the short-side direction (the X-axis direction) of the magnetic member 110. The conductor wire is wound a plurality of times in the coil 130. In the first embodiment, the number of turns of the conductor wire is 12 (12 turns). In the first embodiment, space between adjacent windings of the conductor wire of the coil 130 is 0.56 mm. As the conductor wire of the coil 130, a copper wire can be used, for example. The number of turns and the space between the windings of the conductor wire are only an example. The number of turns and the space between the windings of the conductor wire can be set as appropriate responsive to a change in the size of the antenna device or, more specifically, that in the size of the magnetic member.

Terminal ends on the both sides of the coil 130 are connected to a communication unit of an apparatus that performs communication using the antenna device 100. The communication unit performs communication with an external apparatus.

The magnetic member 110 has grooves 111, the depth of which allows placing a conductor wire therein, in a front surface 110a (first surface) and a back surface 110b (second surface) opposite to the front surface 110a. With this configuration, the conductor wire of the coil 130 is fit in the grooves 111 and wound around the magnetic member 110, so that the conductor wire is positionally fixed in relation to the magnetic member 110. Specifically, the space between the windings of the conductor wire is fixed, so that the conductor wire is fixed so as to prevent displacement of the conductor wire in the long-side direction of the magnetic member 110.

Although the grooves 111 are provided in the both surfaces (the front surface 110a and the back surface 110b) of the magnetic member 110 in the first embodiment, the grooves 111 may alternatively be provided in only any one of the surfaces (one surface). The conductor wire can be positionally fixed even when the grooves 111 are provided in the one surface.

In the first embodiment, although the grooves 111 are provided at positions where the conductor wire to be wound is to be placed, extra grooves may be provided in advance, so that the space between the windings of the conductor wire can be changed without remaking the magnetic member 110.

The antenna device 100 can be manufactured as follows. First, the grooves 111 are formed in the front surface 110a and the back surface 110b of the plate-like magnetic member 110. A conductor wire is placed in the grooves 111 and wound around the magnetic member 110, thereby positionally fixing the conductor wire.

Antenna characteristics are described below. In a coil-type antenna, variation in the coil length directly results in variation in equivalent LCR. The variation in the LCR results in variation in resonant frequency and Q factor, which leads to degradation in communication and power-supply characteristics of the antenna device.

In conventional antenna devices, where no specific consideration is given to fixation of conductor wires, positional displacement of a conductor wire of a coil can occur during transportation of an antenna device or when the antenna device is bent or vibrated during use.

The value of L (inductance) of a coil formed by winding a conductor wire is expressed by the following Equation (1).

L=(K×μ×S×N²)/1 (1)

where

K is the Nagaoka coefficient,

μ is the magnetic permeability,

S is the cross-sectional area of the coil,

N is the number of turns of the conductor wire (number of turns), and

l is the coil length.

The magnetic permeability p in Equation (1) is adjusted during manufacture of the magnetic member. As presented in Equation (1), by positionally fixing the conductor wire of the coil, variations in l (the coil length) and S (the cross-sectional area of the coil) can be simultaneously reduced and, as a result, variations in the antenna characteristics can be reduced.

As described above, the antenna device 100 of the first embodiment includes the grooves 111, in which the conductor wire is fit, provided in the front surface 110a and the back surface 110b of the magnetic member 110 in the short-side direction (the X-axis direction), so that the conductor wire of the coil 130 can be positionally fixed. As a result, reduction in variations in the antenna characteristics can be achieved because the antenna device is less susceptible to a nearby metal object and because positional displacement of the conductor wire is prevented.

### Second Embodiment

The antenna device of the first embodiment includes the grooves in the front surface and the back surface of the magnetic member, so that the conductor wire of the coil is positionally fixed. By contrast, in a second embodiment, grooves are provided in side surfaces of a magnetic member.

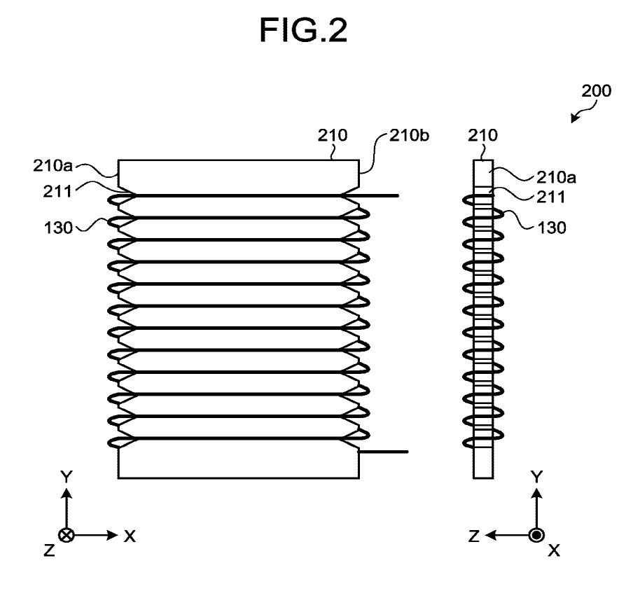

FIG. 2 is a diagram illustrating an antenna device of the second embodiment. An antenna device 200, which is a magnetic-coupling antenna device, includes a magnetic member 210 and the coil 130 as illustrated in FIG. 2. The coil 130 is similar to that of the first embodiment, and repeated description is omitted.

The magnetic member 210 is made of sintered ferrite formed into a rectangular parallelepiped shape that is 5.3 mm in the length A in the short-side direction (the X-axis direction) and 8.7 mm in the length B in the long-side direction (the Y-axis direction), for example. While the magnetic member 210 has the plate-like shape, the shape of the magnetic member 210 may be determined as desired depending on the size, shape, and the like of a space where the antenna device 200 is to be mounted and depending on a necessary communication area, which depends on characteristics of the antenna device 200. The material of the magnetic member 210 is not limited to sintered ferrite, and iron, nickel, manganese, zinc, or an alloy of these metals may alternatively be used so long as it is what is generally referred to as a ferromagnetic material. The magnetic member 210 may be a flexible sheet member having flexibility. The magnetic member 210 may be a member that is deformable to conform to the shape of a casing, to which the magnetic member 210 is to be attached.

The magnetic member 210 has grooves 211, the depth of which allows placing a conductor wire therein, in a side surface 210a (third surface) adjacent to the front surface (see FIG. 2) and a side surface 210b (fourth surface) opposite to the side surface 210a. With this configuration, the conductor wire of the coil 130 is fit in the grooves 211 and wound around the magnetic member 210, so that the conductor wire is positionally fixed in relation to the magnetic member 210. Specifically, the space between the windings of the conductor wire is fixed, so that the conductor wire is fixed so as to prevent displacement of the conductor wire in the long-side direction of the magnetic member 210.

Although the grooves 211 are provided in the both side surfaces (the side surface 210a and the side surface 210b) of the magnetic member 210 in the second embodiment, the grooves 211 may alternatively be provided in only any one of the side surfaces (one surface). The conductor wire can be positionally fixed even when the grooves 211 are provided in the one surface.

Although the grooves 211 are provided in only the side surfaces (the side surface 210a and the side surface 210b) of the magnetic member 210 in the second embodiment, alternatively, the grooves may be provided not only in the side surfaces but also in the front surface and the back surface of the magnetic member 210 as in the first embodiment. When grooves are provided in the four surfaces, the conductor wire can be positionally fixed more precisely.

In the second embodiment, although the grooves 211 are provided at positions where the conductor wire to be wound is to be placed, extra grooves may be provided in advance, so that the space between the windings of the conductor wire can be changed without remaking the magnetic member 210.

The antenna device 200 can be manufactured as follows. First, the grooves 211 are formed in the side surface 210a and the side surface 210b of the plate-like magnetic member 210. A conductor wire is fit in the grooves 211 and wound around the magnetic member 210, thereby positionally fixing the conductor wire.

As described above, the antenna device 200 of the second embodiment includes the grooves 211, in which the conductor wire is fit, provided in the side surface 210a and the side surface 210b of the magnetic member 210 in the thickness direction (the Z-axis direction), so that the conductor wire of the coil 130 can be positionally fixed. As a result, reduction in variations in antenna characteristics can be achieved because the antenna device is less susceptible to a nearby metal object and because positional displacement of the conductor wire is prevented.

### Third Embodiment

The antenna device of the first embodiment includes the grooves provided in the front surface and the back surface of the magnetic member, so that the conductor wire of the coil is positionally fixed. By contrast, in a third embodiment, an adherent layer is provided on a front surface and a back surface of a magnetic member.

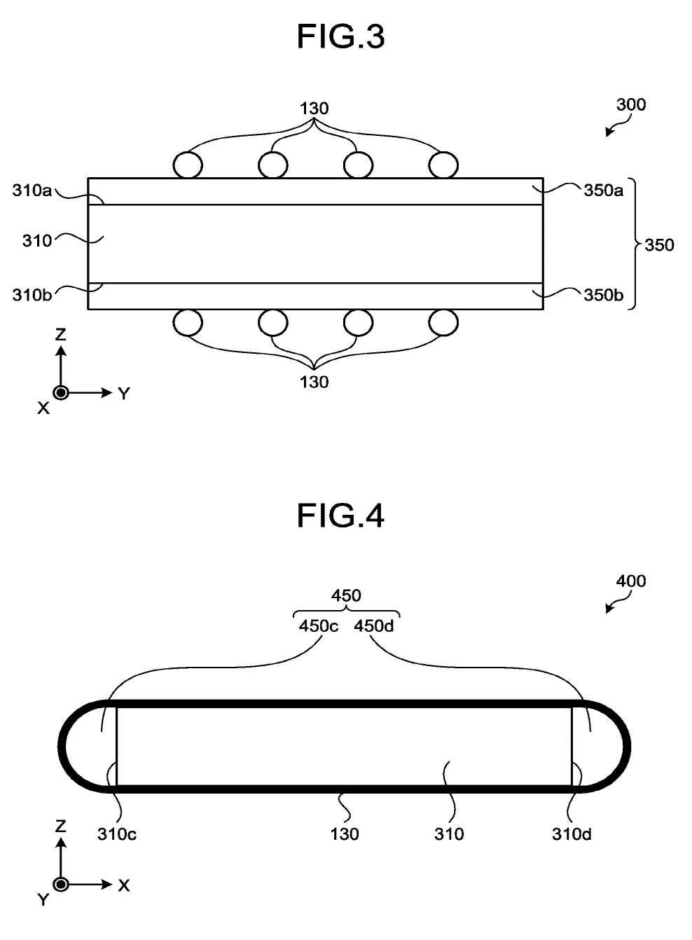

FIG. 3 is a cross-sectional diagram illustrating an antenna device of the third embodiment. An antenna device 300, which is a magnetic-coupling antenna device, includes a magnetic member 310, an adherent layer 350, and the coil 130 as illustrated in FIG. 3.

The magnetic member 310 is made of sintered ferrite formed into a rectangular parallelepiped shape that is 5.3 mm in the length A in the short-side direction (the X-axis direction) and 8.7 mm in the length B in the long-side direction (the Y-axis direction), for example. While the magnetic member 310 has the plate-like shape, the shape of the magnetic member 310 may be determined as desired depending on the size, shape, and the like of a space where the antenna device 300 is to be mounted and depending on a necessary communication area, which depends on characteristics of the antenna device 300. The material of the magnetic member 310 is not limited to sintered ferrite, and iron, nickel, manganese, zinc, or an alloy of these metals may alternatively be used so long as it is what is generally referred to as a ferromagnetic material. The magnetic member 310 may be a flexible sheet member having flexibility. The magnetic member 310 may be a member that is deformable to conform to the shape of a casing, to which the magnetic member 310 is to be attached.

The adherent layer 350 is at least one plate-like, sticky member. The adherent layer 350 includes an adherent layer 350a, which is provided on a front surface 310a (first surface) of the magnetic member 310, and an adherent layer 350b, which is provided on a back surface 310b (second surface) opposite to the front surface 310a.

The coil 130 is similar to that of the first embodiment in terms of thickness of conductor wire, number of turns of the conductor wire, space between windings of the conductor wire, and material. The coil 130 is formed by winding a conductor wire around the magnetic member 310 where the adherent layer 350 is provided. With this configuration, in the coil 130, the conductor wire is positionally fixed by adhesion of the adherent layer 350.

Although the adherent layer 350 is provided on the both surfaces (the front surface 310a and the back surface 310b) of the magnetic member 310 in the third embodiment, the adherent layer 350 may alternatively be provided on only any one of the surfaces (one surface). The conductor wire can be positionally fixed even when the adherent layer 350 is provided on the one surface.

Although the adherent layer 350 is provided on the magnetic member 310 in the third embodiment, the adherent layer may be combined with the configuration of the first embodiment and/or the second embodiment. Specifically, the conductor wire may be wound around the magnetic member 310 where the adherent layer 350 is provided and, furthermore, grooves are provided in at least any one of the front surface, the back surface, and the side surfaces. When the magnetic member 310 is provided with the adherent layer and the grooves, the conductor wire can be positionally fixed more precisely.

The antenna device 300 can be manufactured as follows. First, the adherent layer 350a and the adherent layer 350b that are sticky are provided on (applied to) the front surface 310a and the back surface 310b, respectively, of the plate-like magnetic member 310. A conductor wire is wound around the magnetic member 310 where the adherent layer 350 is provided, so that the conductor wire is positionally fixed by adhesion of the adherent layer 350.

As described above, the antenna device 300 of the third embodiment includes the adherent layers 350a and 350b provided on the front surface 310a and the back surface 310b, respectively, of the magnetic member 310, so that the conductor wire of the coil 130 can be positionally fixed. As a result, reduction in variations in antenna characteristics can be achieved because the antenna device is less susceptible to a nearby metal object and because positional displacement of the conductor wire is prevented. Furthermore, the conductor wire can be positionally fixed only by providing the adherent layer without applying mechanical processing to the magnetic member 310.

### Fourth Embodiment

The antenna device of the third embodiment includes the adherent layer provided on the front surface and the back surface of the magnetic member, so that the conductor wire of the coil is positionally fixed. By contrast, in a fourth embodiment, an adherent layer is provided on side surfaces of a magnetic member.

FIG. 4 is a cross-sectional diagram illustrating an antenna device of the fourth embodiment. An antenna device 400, which is a magnetic-coupling antenna device, includes the magnetic member 310, an adherent layer 450, and the coil 130 as illustrated in FIG. 4.

The magnetic member 310 is similar to that of the third embodiment, and repeated description is omitted.

The adherent layer 450 is at least one plate-like, sticky member. The adherent layer 450 includes an adherent layer 450c, which is provided on a side surface 310c adjacent to the front surface (see FIG. 4) of the magnetic member 310, and an adherent layer 450d, which is provided on a side surface 310d opposite to the side surface 310c.

The coil 130 is similar to that of the first embodiment in terms of thickness of conductor wire, number of turns of the conductor wire, space between the windings of the conductor wire, and material. The coil 130 is formed by winding a conductor wire around the magnetic member 310 where the adherent layer 450 is provided. With this configuration, in the coil 130, the conductor wire is positionally fixed by adhesion of the adherent layer 450.

Although the adherent layer 450 is provided on the both side surfaces (the side surface 310c and the side surface 310d) of the magnetic member 310 in the fourth embodiment, the adherent layer 450 may alternatively be provided on only any one of the surfaces (one surface). The conductor wire can be positionally fixed even when the adherent layer 450 is provided on the one surface.

Although the adherent layer 450 is provided on the magnetic member 310 in the fourth embodiment, the adherent layer may be combined with the configuration of the first embodiment and/or the second embodiment. Specifically, the conductor wire may be wound around the magnetic member 310 where the adherent layer 450 is provided and, furthermore, grooves are provided in at least any one of the front surface, the back surface, and the side surfaces. When the magnetic member 310 is provided with the adherent layer and the grooves, the conductor wire can be positionally fixed more precisely.

The antenna device 400 can be manufactured as follows. First, the adherent layer 450c and the adherent layer 450d that are sticky are provided on (applied to) the side surface 310c and the side surface 310d, respectively, of the plate-like magnetic member 310. A conductor wire is wound around the magnetic member 310 where the adherent layer 450 is provided, so that the conductor wire is positionally fixed by adhesion of the adherent layer 450.

As described above, the antenna device 400 of the fourth embodiment includes the adherent layers 450c and 450d provided on the side surface 310c and the side surface 310d, respectively, of the magnetic member 310, so that the conductor wire of the coil 130 can be positionally fixed. As a result, reduction in variations in antenna characteristics can be achieved because the antenna device is less susceptible to a nearby metal object and because positional displacement of the conductor wire is prevented. Furthermore, the conductor wire can be positionally fixed only by providing the adherent layer without applying mechanical processing to the magnetic member 310.

### Fifth Embodiment

The antenna device of the first embodiment includes the grooves provided in the front surface and the back surface of the magnetic member, so that the conductor wire of the coil is positionally fixed. By contrast, in a fifth embodiment, after winding a conductor wire around a magnetic member, a pressure-bonding member is heat-and-pressure bonded thereto.

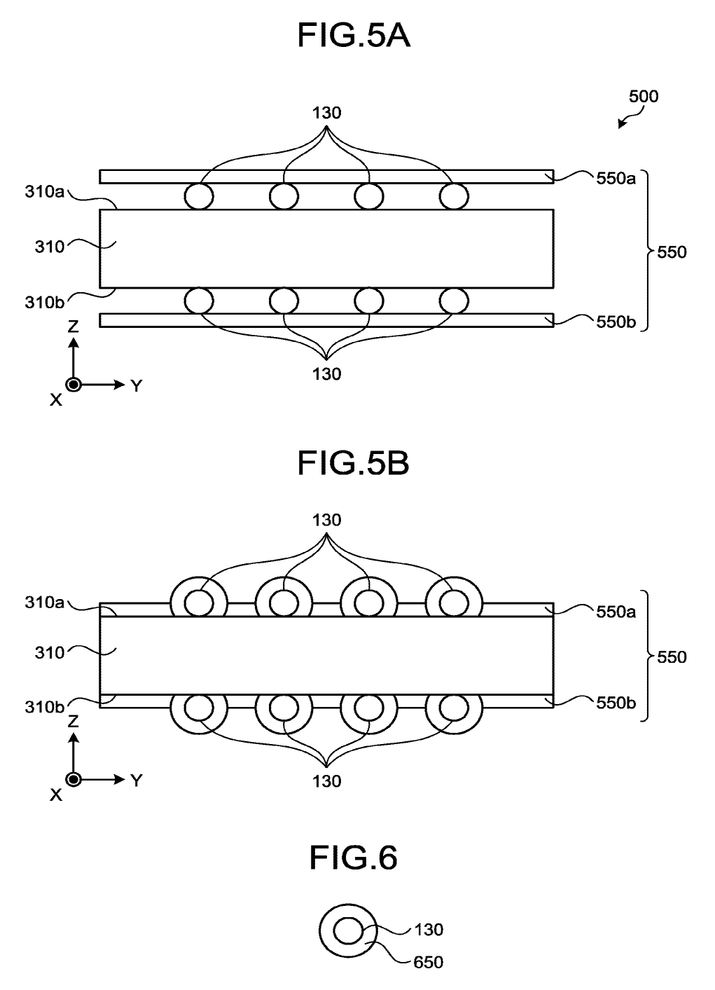

FIG. 5A and FIG. 5B are cross-sectional diagrams illustrating an antenna device of the fifth embodiment. An antenna device 500, which is a magnetic-coupling antenna device, includes the magnetic member 310, the coil 130, and a laminating film 550 as illustrated in FIG. 5A and FIG. 5B. FIG. 5A illustrates the antenna device 500, to which the laminating film 550 is not heat-and-pressure bonded yet. FIG. 5B illustrates the antenna device 500, to which the laminating film 550 has been heat-and-pressure bonded.

The magnetic member 310 is similar to that of the third embodiment, and repeated description is omitted.

The coil 130 is similar to that of the first embodiment in terms of thickness of conductor wire, number of turns of the conductor wire, space between windings of the conductor wire, and material.

The laminating film 550 is at least one pressure-bonding member to be applied to the surface of the magnetic member 310 and the surface of the coil 130 after the coil 130 is formed by winding a conductor wire around the magnetic member 310. In the fifth embodiment, a laminating film 550a is applied to the front surface 310a of the magnetic member 310, and a laminating film 550b is applied to the back surface 310b (see FIG. 5A). The laminating film 550 is heat-and-pressure bonded, thereby positionally fixing the conductor wire wound around the magnetic member 310 (see FIG. 5B). The laminating film 550 may be made of, for example, polyethylene terephthalate (PET) or polypropylene (PP).

Although the laminating film 550 is applied to the both surfaces (the front surface 310a and the back surface 310b) of the magnetic member 310 in the fifth embodiment, the laminating film 550 may alternatively be provided on only any one of the surfaces (one surface). The conductor wire can be positionally fixed even when the laminating film 550 is provided on the one surface.

Although the laminating film 550 is applied to the magnetic member 310 in the fifth embodiment, the laminating film may be combined with the configuration of the first embodiment and/or the second embodiment. Specifically, the conductor wire may be wound around the magnetic member 310 where the laminating film is applied and, furthermore, grooves are provided in at least any one of the front surface, the back surface, and the side surfaces. When the magnetic member 310 is provided with the laminating film and the grooves, the conductor wire can be positionally fixed more precisely.

The antenna device 500 can be manufactured as follows. First, a conductor wire is wound around the magnetic member 310. After the conductor wire has been wound, the laminating film 550a, which is a pressure-bonding member, is applied to the front surface 310a of the magnetic member 310, and the laminating film 550b is applied to the back surface 310b. The laminating films 550a and 550b are then heat-and-pressure bonded, thereby positionally fixing the conductor wire to the magnetic member 310.

As described above, the antenna device 500 of the fifth embodiment include the laminating films 550a and 550b that are applied to the front surface 310a and the back surface 310b, respectively, of the magnetic member 310 and are heat-and-pressure bonded thereto after winding the conductor wire around the magnetic member 310, so that the conductor wire of the coil 130 can be positionally fixed. As a result, reduction in variations in antenna characteristics can be achieved because the antenna device is less susceptible to a nearby metal object and because positional displacement of the conductor wire is prevented. Furthermore, covering the magnetic member 310 and the coil 130 with the laminating film 550 protects the conductor wire and prevents bending of the magnetic member 310, thereby reinforcing the antenna device 500.

### Sixth Embodiment

The antenna device of the first embodiment includes the grooves provided in the front surface and the back surface of the magnetic member, so that the conductor wire of the coil is positionally fixed. By contrast, in a sixth embodiment, a conductor wire, to the surface of which an adhesive is applied, is wound around a magnetic member.

FIG. 6 is a cross-sectional diagram of the conductor wire used in a coil of the sixth embodiment. An antenna device, which is a magnetic-coupling antenna device, of the sixth embodiment includes the magnetic member 310 and the coil 130, which are similar to those of the fifth embodiment.

In the sixth embodiment, as illustrated in FIG. 6, the conductor wire, to the surface of which an adhesive 650 is applied, is wound around the magnetic member 310 in the coil 130. As the adhesive 650, for example, a heat-melting material or a pressure-sensitive adhesive can be used. Winding the conductor wire, the surface of which is coated with the adhesive 650, around the magnetic member 310 in this manner causes the conductor wire to be positionally fixed to the magnetic member 310 by adhesion of the adhesive 650.

Although the conductor wire, to the surface of which the adhesive 650 is applied, is wound around the magnetic member 310 in the sixth embodiment, the adhesive 650 may be combined with the configuration of the first embodiment and/or the second embodiment. Specifically, the conductor wire, to the surface of which the adhesive 650 is applied, may be wound around the magnetic member 310 where grooves are provided in at least any one of the front surface, the back surface, and the side surfaces. When the conductor wire, to which the adhesive 650 is applied, is wound around the magnetic member 310 where the grooves are provided, the conductor wire can be fixed more precisely.

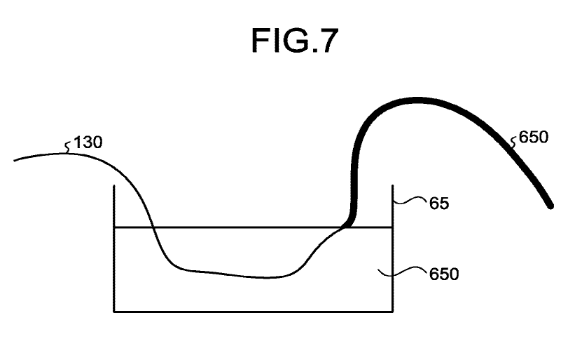

The antenna device of the sixth embodiment can be manufactured as follows. FIG. 7 is a diagram illustrating application of an adhesive to a conductor wire. First, the conductor wire is put in a container 65 containing the adhesive 650, thereby applying the adhesive 650 to the surface of the conductor wire. The conductor wire, to which the adhesive 650 is applied, is wound around the magnetic member 310, so that the conductor wire is positionally fixed by adhesion of the adhesive 650.

As described above, in the antenna device of the sixth embodiment, the conductor wire of the coil 130 can be positionally fixed by virtue of winding a conductor wire, to the surface of which the adhesive 650 is applied, around the magnetic member 310. As a result, reduction in variations in antenna characteristics can be achieved because the antenna device is less susceptible to a nearby metal object and because positional displacement of the conductor wire is prevented. Furthermore, this scheme of applying the adhesive 650 to the conductor wire is adaptable to the magnetic member 310 irrespective of the shape of the magnetic member 310. Furthermore, the adhesive 650 applied to the conductor wire protects the conductor wire, thereby preventing breakage of the conductor wire.

The embodiments can provide an antenna device reduced in variations in antenna characteristics by virtue of being less susceptible to a nearby metal object and less prone to positional displacement of a conductor wire.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

What is claimed is:

1. A coil-type antenna device comprising:
a plate-like magnetic member;
a coil formed by winding a conductor wire around a plate-like magnetic member; and
a fixing structure configured to fix the conductor wire to the magnetic member.

2. The coil-type antenna device according to claim 1, wherein the magnetic member includes the fixing structure.

3. The coil-type antenna device according to claim 2, wherein the fixing structure includes a groove which is provided in the magnetic member and in which the conductor wire is fit.

4. The coil-type antenna device according to claim 1, wherein the fixing structure includes an adherent layer interposed between the magnetic member and the conductor wire.

5. The coil-type antenna device according to claim 1, wherein the fixing structure includes a pressure-bonding member that is heat-and-pressure bonded to the coil.

6. The coil-type antenna device according to claim 1, wherein the fixing structure includes an adhesive applied to the conductor wire to adhere to the magnetic member.
